(19) United States
(12) Patent Application Publication
(10) Pub. No.: US 2012/0166988 A1
(43) Pub. Date: Jun. 28, 2012

(54) SYSTEM AND METHOD FOR PRESENTING PICTURES ON TOUCH SENSITIVE SCREEN

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/210,403

(22) Filed: Aug. 16, 2011

(30) Foreign Application Priority Data
Dec. 28, 2010 (TW) 99146255

(51) Int. Cl. G06F 3/048

(52) U.S. Cl. 715/766

(57) ABSTRACT

A system for presenting pictures on a touch screen is disclosed. The system displays a plurality of pictures associated with a Z-order of layout in the touch screen. When a user selects one of the presented pictures and performs a long tap for a time period on the selected picture, the system changes the Z-order index of the selected picture to a new Z-order index. If necessary, the system adjusts the Z-order indices of the other pictures to accommodate to the new Z-order index of the target picture and generates a new Z-order of layout. Then the system presents the plurality of pictures on the touch screen according to the new Z-order of layout.

### BACKGROUND

1. Technical Field

The disclosure generally relates to a system and a method for presenting pictures on a touch sensitive screen of an electronic device.

2. Description of Related Art

A picture is a two-dimensional object. When a plurality of pictures is displayed in a two-dimensional graphic user interface (GUI) such as a window with a limited display area, the pictures may overlap each other, so that one picture hides part or all of another. When two pictures overlap, their Z-order determines which one appears on top of the other. The term “Z-order” refers to the order of objects along the Z-axis. In coordinate geometry, X typically refers to the horizontal axis (left to right), Y to the vertical axis (up and down), and Z refers to the axis perpendicular to the other two (forward or backward). One can think of the pictures displayed in a GUI as a series of planes parallel to the surface of the monitor. The pictures are therefore stacked along the Z-axis, and the Z-order information thus specifies the front-to-back ordering of the pictures on the computer screen.

However, it is not convenient for a picture viewer to adjust the Z-order of pictures when the pictures are already displayed on the computer screen because the Z-order of pictures is always preset before being displayed. Therefore, there is room for improvement in the Z-order adjustment of displayed pictures.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of an electronic device suitable for use in implementing a picture presenting system.

FIG. 2 is a schematic diagram of one embodiment of the function modules of the picture presenting system of FIG. 1.

FIG. 3 illustrates a view of a graphic user interface for presenting an ordering list of pictures and a corresponding Z-order index table in one embodiment.

FIG. 4 is an operational flow diagram representing one exemplary embodiment of a method for presenting pictures on a touch sensitive screen.

FIG. 5 is an operational flow diagram representing one exemplary embodiment of a method for adjusting the Z-order of the pictures in an increment mode.

FIG. 6 is an operational flow diagram representing one exemplary embodiment of a method for adjusting the Z-order of the pictures in a decrement mode.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

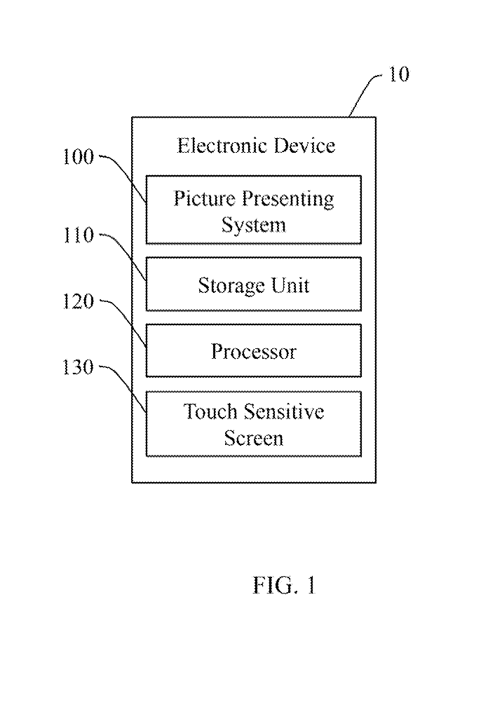

FIG. 1 is a schematic diagram of one embodiment of an electronic device 10. The electronic device 10 may include a picture presenting system 100, a storage unit 110, at least one processor 120, and a touch sensitive screen 130. The electronic device 10 implements the functions of the picture presenting system 100. The electronic device 10 is a general purpose computing device with a touch sensitive screen such as an all-in-one computer, a tablet computer, a personal digital assistant (PDA), or a smart phone. The storage unit 110 may be a magnetic or an optical storage device, such as a hard disk drive, an optical drive, or a tape drive. The storage unit 110 may store a plurality of pictures, which could be displayed by the picture presenting system 100.

The touch sensitive screen 130 is an electronic visual display that can detect the presence and location of a touch event within the display area. A variety of touch events may be detected by the touch sensitive screen 130, such as a short tap that touches the screen and releases immediately, a long tap that touches the screen and holds for a while, a double tap that taps the screen twice without much delay, and a drag-and-drop that touches the screen, holds, moves and then releases.

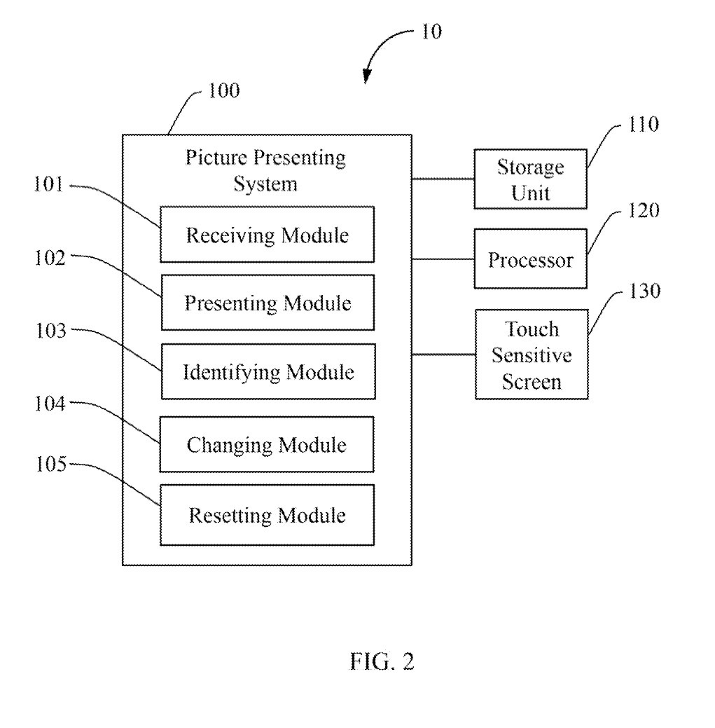

FIG. 2 is a schematic diagram of one embodiment of the function modules of the picture presenting system 100. The picture presenting system 100 may include a receiving module 101, a presenting module 102, an identifying module 103, a changing module 104, and a resetting module 105.

The receiving module 101 may receive a plurality of pictures associated with a Z-order of layout in a presentation. Each of the plurality of pictures has an attribute named Z-order index, which specifies the number of the layer where the corresponding picture is presented. As a value of the Z-order index, “0” or an integral number can be set. A picture with a greater Z-order index will be displayed on the front side of another picture with a smaller Z-order index. By contrast, a picture with a smaller Z-order index will be displayed on the rear side of another one with a greater Z-order index. In another embodiment, a lower limit value, for example “0”, may be defined as the minimum value of the Z-order index. In addition, an upper limit value, for example the amount of the total pictures, may be determined as the maximum value of the Z-order index. If a Z-order index of a picture is out of the defined range, the Z-order index may be treated as an invalid Z-order index and a new valid value may reassigned to the picture.

The presenting module 102 may present the plurality of pictures on the touch sensitive screen 130 according to the Z-order of layout. The plurality of pictures can be displayed to partially overlap each other based on the Z-order index of each of the plurality of pictures.

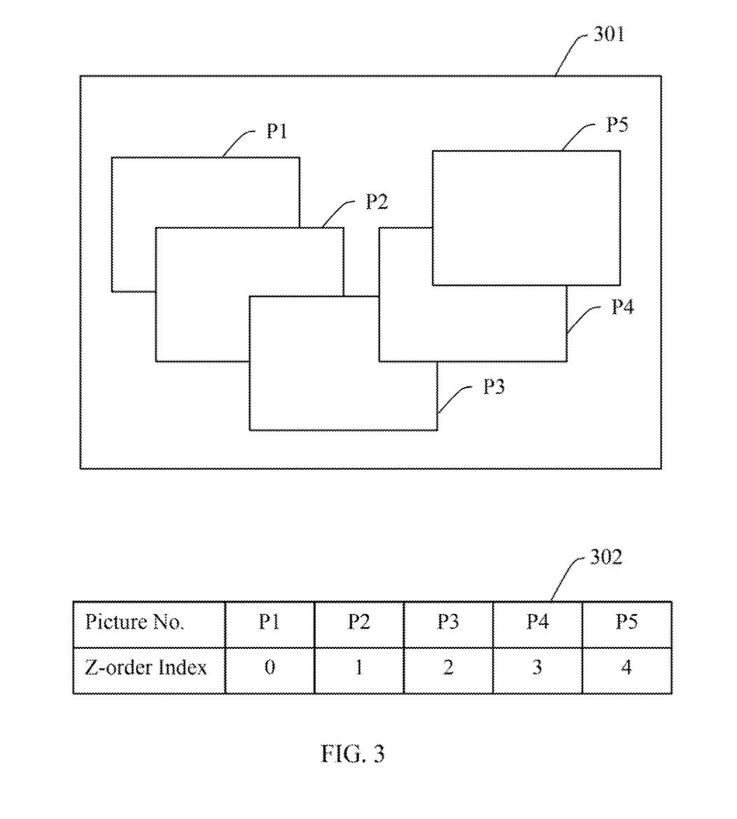

With reference to FIG. 3, an example of a graphic user interface (GUI) 301 for displaying pictures and a corresponding Z-order index table 302 are illustrated. In this example, five pictures P1-P5 are displayed in the GUI 301. Each of the pictures P1-P5 is associated with a Z-order index depicted in the Z-order index table 302. As shown in the Z-order index table 302, the picture P1 has the smallest Z-order index “0” and the picture P5 has the greatest Z-order index “4”. Thereby the picture P1 is laid out at the rearmost side and the picture P5 is laid out at the foremost side.

The identifying module 103 may identify a target picture from the plurality of pictures according to a selection touch on the touch sensitive screen 130. When a user performs a short tap on a position of the touch sensitive screen 130 where at least one segment of a picture is presented, the selection touch is determined and the picture is selected as the target picture of which the Z-order index needs to be adjusted by the user.

The changing module 104 may change the Z-order index of the target picture to a new Z-order index according to an execution touch on the touch sensitive screen 130. The user performs a long tap for a time period on a position of the touch sensitive screen 130 where at least one segment of the target picture is presented. When the period of time reaches a predetermined threshold, such as 2 seconds, the execution touch is determined and the changing module 104 can start a change process to change the Z-order index of the target picture. When the Z-order index of the target picture is changed to a new value, the resetting module 105 may reset the Z-order indices of the plurality of pictures except for the target picture to accommodate to the new Z-order index of the target picture.

The changing module 104 may work in an increment mode or a decrement mode. The detailed process performed by the change module 104 in the increment mode or the decrement mode is described as below.

When the changing module 104 works in the increment mode, the changing module 104 increases the Z-order index of the target picture by a value such as “1” every a predetermined time period, such as 500 milliseconds, until the time period of the execution touch times out or the new Z-order index reaches the upper limit value. When the Z-order index of the target picture has been changed from the original value to a new value, the resetting module 105 compares the Z-order indices of other pictures to the original Z-order index of the target picture. If the Z-order index of one picture is greater than the original Z-order index of the target picture and not greater than the new Z-order index of the target picture, the resetting module 105 decreases the Z-order index of the picture by “1”.

When the changing module 104 works in the decrement mode, the changing module 104 decreases the Z-order index of the target picture by a value such as “1” every a predetermined time period, such as 500 milliseconds, until the time period of the execution touch times out or the new Z-order index reaches the lower limit value. When the Z-order index of the target picture has been changed from the original value to a new value, the resetting module 105 compares the Z-order indices of other pictures to the original Z-order index of the target picture. If the Z-order index of one picture is smaller than the original Z-order index of the target picture and not smaller than the new Z-order index of the target picture, the resetting module 105 increases the Z-order index of the picture by “1”.

The presenting module 102 may present the plurality of pictures on the touch sensitive screen 130 according to the new Z-order of layout.

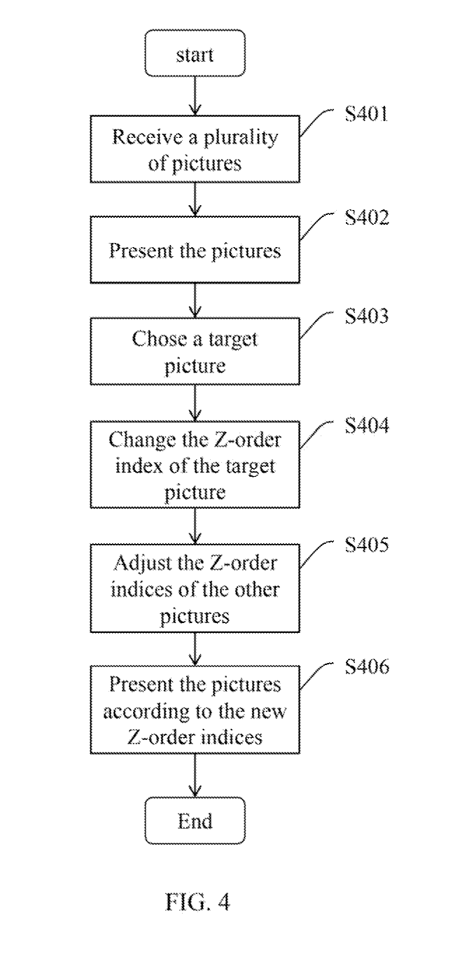

FIG. 4 is a flowchart illustrating one embodiment of a method for presenting pictures on a touch sensitive screen. The method may include the following steps.

In step S401, the receiving module 101 receives a plurality of pictures associated with a Z-order of layout in a presentation. Each of the plurality of pictures has an attribute named Z-order index, which specifies the number of the layer where the corresponding picture is presented. As a value of the Z-order index, “0” or an integral number can be set.

In step S402, the presenting module 102 presents the plurality of pictures on the touch sensitive screen 130 according to the Z-order of layout. The plurality of pictures can be displayed to partially overlap each other based on the Z-order index of each of the plurality of pictures.

In step S403, the identifying module 103 identifies a target picture from the plurality of pictures according to a selection touch on the touch sensitive screen 130.

In step S404, the changing module 104 changes the Z-order index of the target picture to a new Z-order index according to an execution touch on the touch sensitive screen 130.

In step S405, the resetting module 105 resets the Z-order indices of the plurality of pictures except for the target picture to accommodate to the new Z-order index of the target picture to generate a new Z-order of layout.

In step S406, The presenting module 102 presents the plurality of pictures on the touch sensitive screen 130 according to the new Z-order of layout.

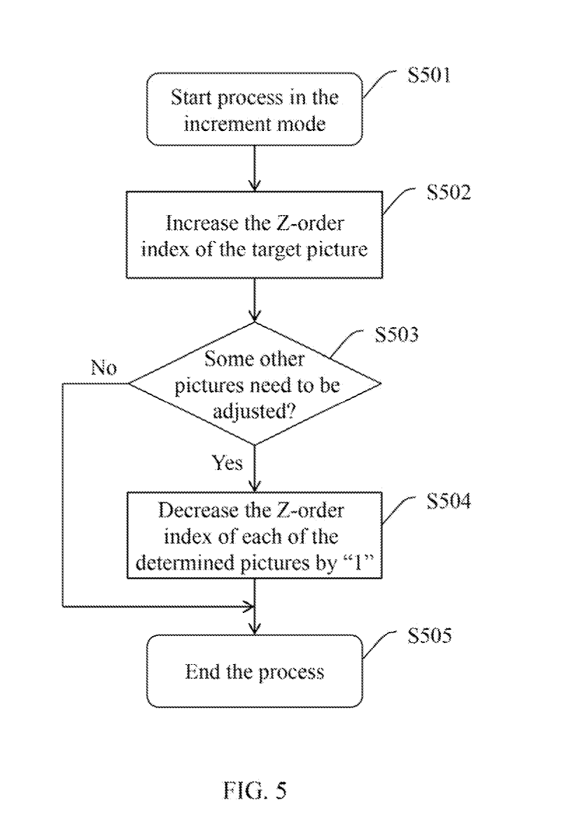

FIG. 5 is a flowchart illustrating one embodiment of a method for adjusting the Z-order of the pictures in an increment mode. The method may include the following steps.

In step S501, the adjustment process starts in the increment mode.

In step S502, the changing module 104 increases the Z-order index of the target picture by a value such as “1” every a predetermined time period such as 500 millisecond until the time period of the execution touch times out or the new Z-order index reaches the upper limit value.

In step S503, the resetting module 105 compares the Z-indices of other pictures to the original Z-order index of the target picture. If the Z-order index of one picture is greater than the original Z-order index of the target picture and not greater than the new Z-order index of the target picture, the resetting module 105 determines that the Z-order of the picture needs to be adjusted. If at least one picture matches the adjustment criterion, the flow goes to step S504, otherwise the flow goes to step S505.

In step S504, the resetting module 105 decreases the Z-order index of each of the determined pictures by “1”.

In step S505, the adjustment process ends.

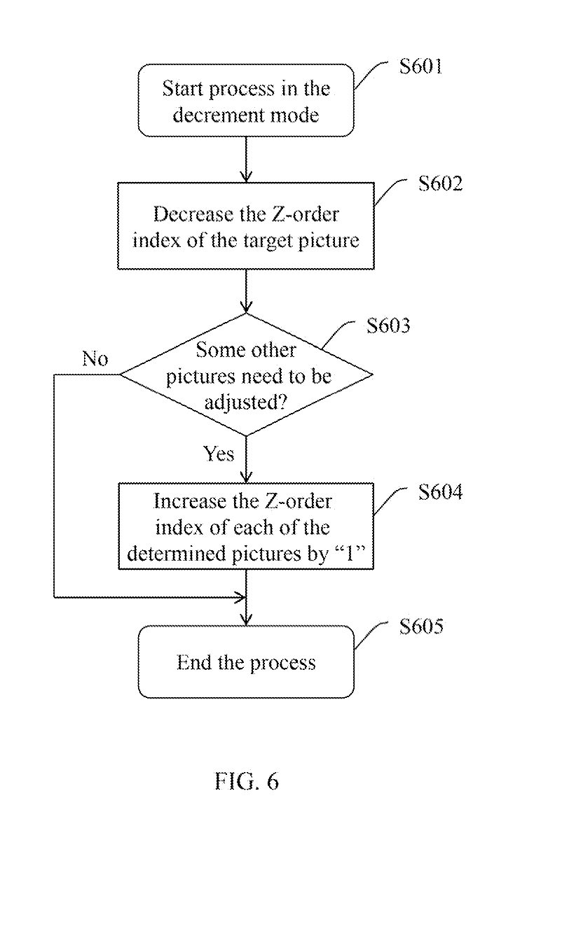

FIG. 6 is a flowchart illustrating one embodiment of a method for adjusting the Z-order of the pictures in a decrement mode. The method may include the following steps.

In step S601, the adjustment process starts in the decrement mode.

In step S602, the changing module 104 decreases the Z-order index of the target picture by a value such as “1” every a predetermined time period, such as 500 milliseconds, until the time period of the execution touch times out or the new Z-order index reaches the lower limit value.

In step S603, the resetting module 105 compares the Z-indices of other pictures to the original Z-order index of the target picture. If the Z-order index of one picture is smaller than the original Z-order index of the target picture and not smaller than the new Z-order index of the target picture, the resetting module 105 determines that the Z-order of the picture needs to be adjusted. If at least one picture matches the adjustment criterion, the flow goes to step S604, otherwise the flow goes to step S605.

In step S604, the resetting module 105 increases the Z-order index of each of the determined pictures by “1”.

In step S605, the adjustment process ends.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for presenting pictures on a touch-sensitive display screen of an electronic device, the method comprising:
receiving a plurality of pictures associated with a Z-order of layout in a presentation;
presenting the plurality of pictures on the touch-sensitive display screen according to the Z-order of layout;
identifying a target picture from the plurality of pictures according to a selection touch on the touch-sensitive display screen;
changing Z-order index of the target picture to a new Z-order index according to an execution touch on the touch-sensitive display screen;
resetting Z-order indices of the plurality of pictures except for the target picture to accommodate to the new Z-order index of the target picture to generate a new Z-order of layout; and
displaying the plurality of pictures on the touch-sensitive display screen according to the new Z-order of layout.

2. The method of claim 1, wherein Z-order index is zero or integral number.

3. The method of claim 1, wherein the plurality of pictures is presented to partially overlap each other.

4. The method of claim 1, wherein the selection touch comprises a short tap on a position of the touch-sensitive display screen without holding where a segment of the target picture is displayed.

5. The method of claim 1, wherein the execution touch comprises a long tap on a position of the touch-sensitive display screen with holding for a time period where a segment of the target picture is displayed.

6. The method of claim 5, wherein the changing Z-order index comprises increasing the Z-order index of the target picture by a value every a predetermined time period until the time period times out or the new Z-order index reaches an upper limit value.

7. The method of claim 6, wherein the resetting Z-order indices comprises:
determining a picture of the plurality of pictures, wherein Z-order index of the picture is greater than the Z-order index of the target picture and not greater than the new Z-order index of the target picture; and
decreasing the Z-order index of the picture by the value.

8. The method of claim 5, wherein the changing Z-order index comprises decreasing the Z-order index of the target picture by a value every a predetermined time period until the time period times out or the new Z-order index reaches an lower limit value.

9. The method of claim 8, wherein the resetting Z-order indices comprises:
determining a picture of the plurality of pictures, wherein Z-order index of the picture is smaller than the Z-order index of the target picture and not smaller than the new Z-order index of the target picture; and
increasing the Z-order index of the picture by the value.

10. The method of claim 5, wherein the execution touch is determined when the time period reaches a predetermined threshold.

11. A system for presenting pictures on a touch-sensitive display screen of an electronic device, the system comprising:
a receiving module adapted to receive a plurality of pictures associated with a Z-order of layout in a presentation;
a presenting module adapted to present the plurality of pictures on the touch-sensitive display screen according to the Z-order of layout;
an identifying module adapted to identify a target picture from the plurality of pictures according to a selection touch on the touch-sensitive display screen;
a changing module adapted to change Z-order index of the target picture to a new Z-order index according to an execution touch on the touch-sensitive display screen;
a resetting module adapted to reset Z-order indices of the plurality of pictures except for the target picture to accommodate to the new Z-order index of the target picture to generate a new Z-order of layout; and
wherein the presenting module is further adapted to present the plurality of pictures on the touch-sensitive display screen according to the new Z-order of layout.

12. The system of claim 11, wherein the Z-order index is zero or integral number.

13. The system of claim 11, wherein the plurality of pictures is presented to partially overlap each other.

14. The system of claim 11, wherein the selection touch comprises a short tap on a position of the touch-sensitive display screen without holding where a segment of the target picture is displayed.

15. The system of claim 11, wherein the execution touch comprises a long tap on a position of the touch-sensitive display screen with holding for a time period where a segment of the target picture is displayed.

16. The system of claim 15, wherein the changing module is further adapted to increase the Z-order index of the target picture by a value every a predetermined time period until the time period times out or the new Z-order index reaches an upper limit value.

17. The system of claim 16, wherein the resetting module is further adapted to determine a picture of the plurality of pictures, wherein the Z-order index of the picture is greater than the Z-order index of the target picture and not greater than the new Z-order index of the target picture, and decrease the Z-order index of the picture by the value.

18. The system of claim 15, wherein the changing module is further adapted to decrease the Z-order index of the target picture by a value every a predetermined time period until the time period times out or the new Z-order index reaches an lower limit value.

19. The system of claim 18, wherein the resetting module is further adapted to determine a picture of the plurality of pictures, wherein Z-order index of the picture is smaller than the Z-order index of the target picture and not smaller than the new Z-order index of the target picture, and increase the Z-order index of the picture by the value.

20. A computer-implemented method for presenting pictures on a touch-sensitive display screen of an electronic device, the method comprising:
providing a receiving module, a presenting module, an identifying module, a changing module, and a resetting module;
receiving a plurality of pictures associated with a Z-order of layout in a presentation by the receiving module;
presenting the plurality of pictures on the touch-sensitive display screen according to the Z-order of layout by the presenting module;
identifying a target picture from the plurality of pictures according to a selection touch on the touch-sensitive display screen by the identifying module;
changing Z-order index of the target picture to a new Z-order index according to an execution touch on the touch-sensitive display screen by the changing module;
resetting Z-order indices of the plurality of pictures except for the target picture to accommodate to the new Z-order index of the target picture to generate a new Z-order of layout by the resetting module; and
displaying the plurality of pictures on the touch-sensitive display screen according to the new Z-order of layout by the presenting module.
